(19) United States
(12) Patent Application Publication
(10) Pub. No.: US 2011/0290367 A1
(43) Pub. Date: Dec. 1, 2011

(54) SPIRAL TUBE FOR PRESSURE-SUPPORTING AND EASY PULL-OUT

(75) Inventors: Kwang Hwan OH, Gunpo-si (KR); Doo Sung SHIN, Gumi-si (KR); Mi Kyoung AN, Daegu (KR); Hyun Young OH, Gumi-si (KR); Jong Seok JEON, Gumi-si (KR)

(73) Assignee: LS CABLE LTD., Anyang-si (KR)

(21) Appl. No.: 13/149,229

(22) Filed: May 31, 2011

(30) Foreign Application Priority Data
Jun. 1, 2010 (KR) 10-2010-0051565

(51) Int. Cl. F16L 9/22

(52) U.S. Cl. 138/155

(57) ABSTRACT

A strip-connecting type spiral tube is configured so that strip members serving as segments are connected to each other. The strip-connecting type spiral tube for pressure-supporting and easy pull-out has a new-type connection structure of strip members, which allow easy and convenient pull-out of strip members adjacently connected and prevents an arrangement of strip members from collapsing due to an external pressure.

### CROSS-REFERENCE TO RELATED APPLICATION

This application claims priority to Korean Patent Application No. 2010-51565, filed on Jun. 1, 2010, and all the benefits accruing therefrom under 35 U.S.C. §119, the contents of which in its entirety are herein incorporated by reference.

### BACKGROUND

1. Field

The present disclosure relates to a spiral tube for pressure-supporting and easy pull-out, and more particularly to a new-type connection structure allowing easy pull-out between strip members adjacent to each other and preventing collapse between strip members caused by pressure-supporting.

2. Description of the Related Art

Generally, a strip-connecting type spiral tube is used in a condition which pressure is applied, for the purpose of protecting components against the applied pressure. The spiral tube has strip members configured as segments that are adjacent to each other while forming a spiral strip.

U.S. Pat. Nos. 5,925,427 and 5,670,223 disclose examples of a connection structure between strip members, which configure the strip-connecting type spiral tube.

FIGS. 1 and 2 are sectional views showing examples of a connection structure between strip members disclosed in U.S. Pat. Nos. 5,925,427 and 5,670,223, where FIG. 1 shows an example disclosed in U.S. Pat. No. 5,925,427, and FIG. 2 shows an example disclosed in U.S. Pat. No. 5,670,223.

For the convenience of explanation, a protrusion side and a hook side will be distinguished to avoid any confusion.

As shown in FIGS. 1 and 2, seeing a connection structure of strip members 10, 12, 30 and 32 adjacent to each other, protrusion-side and hook-side coupling projections 14, 34, 16 and 36 are respectively formed at both ends of the strip members 10, 12, 30 and 32.

First, the protrusion-side coupling projection 14 and 34 formed at one end has an upper surface in which a protrusion-side arc-type convex surface 18, 38 and a protrusion-side arc-type concave surface 20 and 40 are subsequently formed from the front end of the protrusion-side coupling projection 14 and 34 toward a root portion.

The hook-side coupling projection 16 and 36 formed at the other end has an upper surface in which a hook-side arc-type convex surface 22 and 42 and a hook-side arc-type concave surface 24 and 44 are subsequently formed from the front end of the hook-side coupling projection 16 and 36 toward a root portion.

When the strip members 10, 12, 30 and 32 adjacent to each other are connected, the protrusion-side arc-type convex surface 18 and 38 and the protrusion-side arc-type concave surface 20 and 40 are engaged with the hook-side arc-type convex surface 22 and 42 and the hook-side arc-type concave surface 24 and 44.

### SUMMARY

The present disclosure is designed to solve problems of the existing art. In the connection structure between the strip members 10 and 12 disclosed in U.S. Pat. No. 5,925,427, the hook-side coupling projection 16 and the adjacent protrusion-side coupling projection 14 are engaged too deeply, and particularly, when being coupled, their cross-sections are coupled without any gap, which results in interference and narrowing during a pull-out process. Thus, it is very difficult to pull out them.

Meanwhile, in the connection structure between the strip members 30 and 32 disclosed in U.S. Pat. No. 5,670,223, a gap space S is formed between the hook-side coupling projection 36 and the protrusion-side coupling projection 34, which ensures easy pull-out. However, if an external pressure is applied thereto, the strip members 30 and 32 may collapse due to the excessive gap space S, and thus safety against pressure-supporting is not ensured.

Therefore, the present disclosure is directed to providing a connection structure, which allows easy pull-out between strip members adjacently connected and also prevents the arrangement of strip members from collapsing due to an external pressure.

In one aspect, there is provided a strip-connecting type spiral tube for pressure-supporting and easy pull-out, which includes strip members, which are segments, protrusion-side and hook-side coupling projections being respectively formed at both ends of the strip members, so that the strip members adjacent to each other are connected by coupling the protrusion-side and hook-side coupling projections, wherein the protrusion-side coupling projection has an upper surface in which a protrusion-side arc-type convex surface and a protrusion-side arc-type concave surface are formed subsequently from a front end of the coupling projection toward a root portion, and the hook-side coupling projection has an upper surface in which a hook-side arc-type convex surface and a hook-side arc-type concave surface are subsequently formed from a front end of the coupling projection toward a root portion, wherein the hook-side arc-type convex surface of the hook-side coupling projection has an arc of a base circle with a radius, a region between a bottom side and the hook-side arc-type concave surface having an arc of a base circle with a radius, and wherein the protrusion-side arc-type convex surface has an arc of a base circle with a radius, a region between an upper side and the protrusion-side arc-type concave surface having an arc of a base circle with a radius.

When the strip member is released with a releasing angle, the following mathematical formulas may be satisfied so as to prevent arrangement collapse caused by pressure-supporting and allow upper and lower pull-out of the strip members:

$$d > ( 1 - {ɛ}_{f} ) [ {r}_{i} ( \frac{1}{sin θ} - 1 ) + {r}_{2} ( \frac{1}{sin θ} - 1 ) + ( a - {r}_{1} ) ( \frac{1}{sin θ cos θ} - tan θ ) ]$$

$$a > d$$

$${ɛ}_{f} > ( \frac{1}{sin θ} - 1 ) + \frac{b}{( {r}_{3} + {r}_{4} ) tan θ }$$

### BRIEF DESCRIPTION OF THE DRAWINGS

The above and other aspects, features and advantages of the disclosed exemplary embodiments will be more apparent from the following detailed description taken in conjunction with the accompanying drawings in which:

FIGS. 1 and 2 are sectional views respectively showing connection structures between adjacent strip members, in existing strip-connecting type spiral tubes;

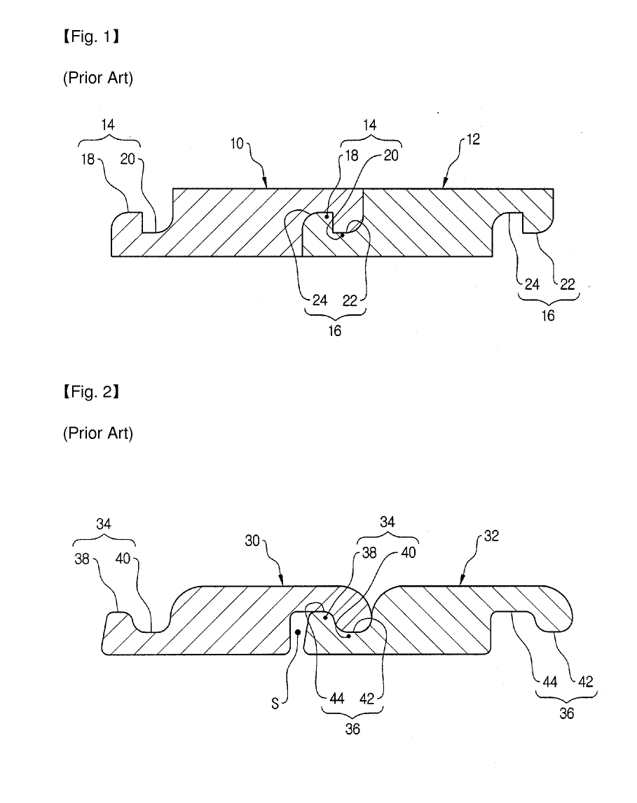

FIG. 3 is a schematic view for illustrating a connection structure between adjacent strip members, in a strip-connecting type spiral tube for pressure-supporting and easy pull-out disclosed herein;

FIGS. 4A and 4B show essential portions of a lower connection structure between strip members, in a strip-connecting type spiral tube for pressure-supporting and easy pull-out disclosed herein, wherein FIG. 4A shows a connection structure in which strip members are pulled out without any interference and FIG. 4B shows a connection structure in which strip members may be pulled out even when an interference is generated therebetween;

FIG. 5 shows a lower connection structure between strip members for pressure-supporting, free from collapsing, in a strip-connecting type spiral tube for pressure-supporting and easy pull-out disclosed herein;

FIG. 6 shows an upper connection structure between strip members for pressure-supporting and easy pull-out, in a strip-connecting type spiral tube for pressure-supporting and easy pull-out disclosed herein; and

FIGS. 7A to 7B are schematic views respectively showing connection structures of strip members depending on whether or not Mathematical Formula 2, Mathematical Formula 3, and Mathematical Formula 6 are satisfied.

### DETAILED DESCRIPTION

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals denote like elements. The shape, size and regions, and the like, of the drawing may be exaggerated for clarity.

Hereinafter, a preferred embodiment of a strip-connecting type spiral tube for pressure-supporting and easy pull-out disclosed herein will be described with reference to the accompanying drawings.

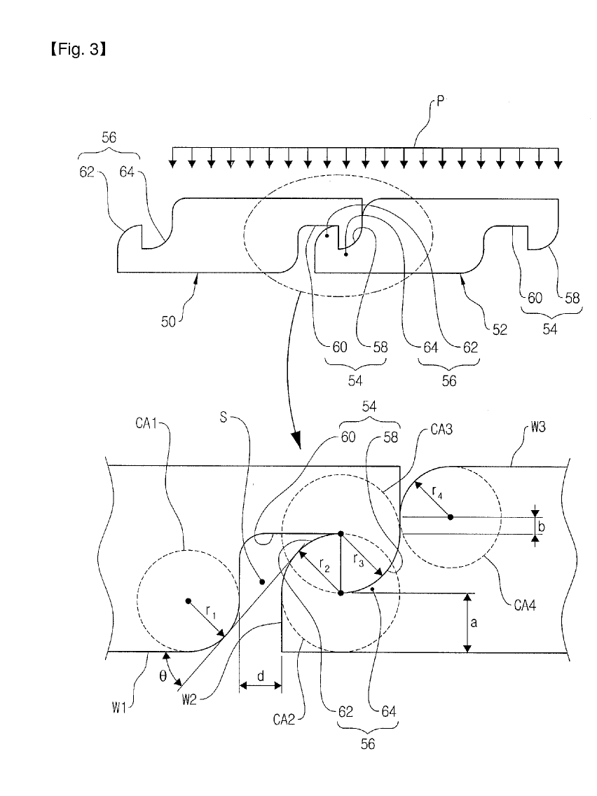

FIG. 3 is a schematic view for illustrating a connection structure between adjacent strip members, in a strip-connecting type spiral tube for pressure-supporting and easy pull-out disclosed herein.

For the convenience of explanation, a protrusion side and a hook side will be distinguished to avoid any confusion, and a scrip member will be described based on a left side and a right side based on the disposed location.

As shown in the figures, the strip-connecting type spiral tube includes hook-side and protrusion-side coupling projections 54 and 56 respectively formed at both ends of the strip members 50 and 52, similarly to the existing case, and the hook-side and protrusion-side coupling projections 54 and 56 are oppositely oriented in upper and lower directions.

When the left and right strip members 50 and 52 adjacent to each other are connected, the hook-side coupling projection 54 of the strip member 50 disposed at the left is hooked to the protrusion-side coupling projection 56 of the strip member 52 located at the right.

Accordingly, the protrusion-side arc-type convex surface 62 and the protrusion-side arc-type concave surface 64 are engaged with the hook-side arc-type convex surface 58 and the hook-side arc-type concave surface 60, respectively.

In more detail, the hook-side arc-type convex surface 58 of the hook-side coupling projection 54 of the left strip member 50 has an arc of a base circle CA3 with a radius r₃.

In addition, a region between the bottom side W1 of the left strip member 50 and the hook-side arc-type concave surface 60 is formed with an arc having a base circle CA1 with a radius r₁.

One end of the arc with the radius r₁ meets the bottom side W1 of the left strip member 50 to smoothly extend thereto, and the other end meets a linear region extending from the hook-side arc-type concave surface 60 to smoothly extend thereto.

The protrusion-side arc-type convex surface 62 of the right strip member 52 is formed with an arc of a base circle CA2 with a radius r₂. The arc with the radius r₂ has one end that meets a side W2 of the right strip member 52 to smoothly extend thereto, and the other end that meets the protrusion-side arc-type concave surface 64.

A region between the upper side W3 of the right strip member 52 and the protrusion-side arc-type concave surface 64 is formed with an arc of a base circle CA4 with a radius r₄. One end of the arc meets the upper side W3 of the right strip member 52 to smoothly extend thereto, and the other end meets a linear region extending from the protrusion-side arc-type concave surface 64 to smoothly extend thereto.

In the drawings, r₁, r₂, r₃, and r₄ are arc radii, a is a thickness between the center point of r₂ and the bottom side W1, b is a distance between the center point of r₃ and the center point of r₄, d is a spacing interval for a gap space S, θ is a releasing angle at which the right strip member 52 is separated, and P is pressure.

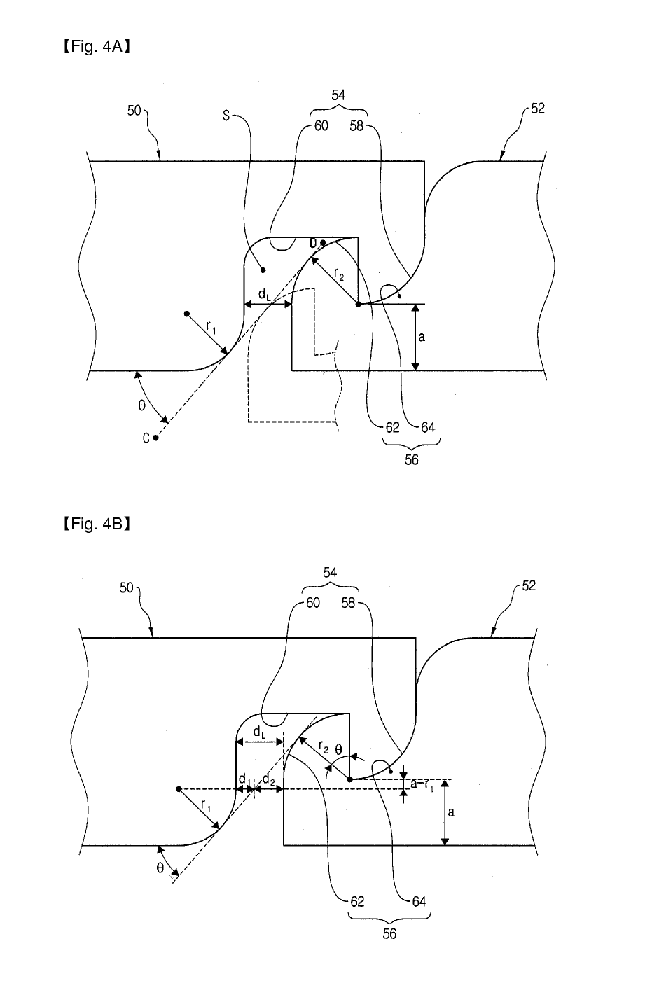

FIGS. 4A and 4B show essential portions of a lower connection structure between strip members, in a strip-connecting type spiral tube for pressure-supporting and easy pull-out disclosed herein, wherein FIG. 4A shows a connection structure in which strip members are pulled out without any interference and FIG. 4B shows a connection structure in which strip members may be pulled out even when an interference is generated therebetween.

As shown in FIG. 4A, assuming that the right strip member 52 is pulled out, seeing minimal conditions not to cause interference, the right strip member 52 does not come into contact with the left strip member 50 when being released within lines C and D having a releasing angle θ as boundaries.

Seeing relations among the spacing interval d of the gap space S, the arc radii r₁ and r₂, and thickness a between the center point of the arc radius 2 and the bottom side W1, the spacing interval d should be formed to be greater than a spacing interval d_{L} that is generated when the arc radii r₁ and r₂ and the thickness a are set. In other words, this relation may be expressed as by the inequality: d>d_{L} (see FIG. 3).

Thus, the spacing interval d for the spacing gap S allowing the right strip member 52 to be released within the lines C and D as boundaries without any contact with the left strip member 50 satisfies Mathematical Formula 1.

$$Mathematical Formula 1$$

$$d > {r}_{1} ( \frac{1}{sin θ} - 1 ) + {r}_{2} ( \frac{1}{sin θ} - 1 ) + ( a - {r}_{1} ) ( \frac{1}{sin θ cos θ} - tan θ )$$

$${d}_{L} = {d}_{1} + {d}_{2}$$

$${d}_{1} = {r}_{1} ( \frac{1}{sin θ} - 1 )$$

$${d}_{2} = {r}_{2} ( \frac{1}{sin θ} - 1 ) + ( a - {r}_{1} ) ( \frac{1}{sin θ cos θ} - tan θ )$$

In FIG. 4B, interference is generated between the right strip member 52 and the left strip member 50, causing shrinkage to the right and left strip members 52 and 50, and this connection structure is not dismantled due to the shrinkage even when the spacing interval d_{L} is decreased. In other words, in order to obtain a connection structure that may be dismantled when shrinkage occurs, a maximum strain ε_{f} of the left and right strip members 50 and 52 should be further applied. For this condition, Mathematical Formula 2 should be satisfied.

$$Mathematical Formula 2$$

$$d > ( 1 - {ɛ}_{f} ) [ \begin{matrix}{r}_{1} ( \frac{1}{sin θ} - 1 ) + {r}_{2} ( \frac{1}{sin θ} - 1 ) + \\ ( a - {r}_{1} ) ( \frac{1}{sin θ cos θ} - tan θ )\end{matrix} ]$$

For reference, ε_{f} is a maximum strain on the material of the strip member, and a−r₁ is a distance between the center point of r₁ and the center point of r₂ (see FIG. 3).

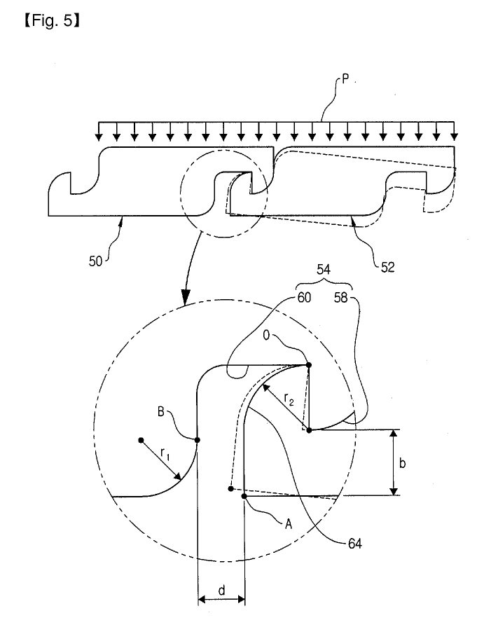

FIG. 5 shows a lower connection structure between strip members for pressure-supporting, free from collapsing, in a strip-connecting type spiral tube for pressure-supporting and easy pull-out disclosed herein.

As shown in FIG. 5, when pressure is applied while connection is made between the left and right strip members 50 and 52, the strip member 52 finally connected tends to rotate about a point O. At this time, if the spacing interval d is great as in an existing case, great rotational distortion is generated, leading to collapse of the arrangement.

In order to prevent such collapse of arrangement, the connection structure should be configured to stop rotation if the point A of the right strip member 52 comes into contact with the point B of the left strip member 50 while the right strip member 52 rotates. That is, the following condition should be satisfied.

a>d Mathematical Formula 3

By using Mathematical Formulas 1 to 3, it is possible to derive a condition for obtaining a connection structure in which the arrangement does not collapse at pressure-supporting and easy pull-out is allowed at the same time. The condition is as follows.

$$Mathematical Formula 4$$

$$a > d > ( 1 - {ɛ}_{f} ) [ \begin{matrix}{r}_{1} ( \frac{1}{sin θ} - 1 ) + {r}_{2} ( \frac{1}{sin θ} - 1 ) + \\ ( a - {r}_{1} ) ( \frac{1}{sin θ cos θ} - tan θ )\end{matrix} ]$$

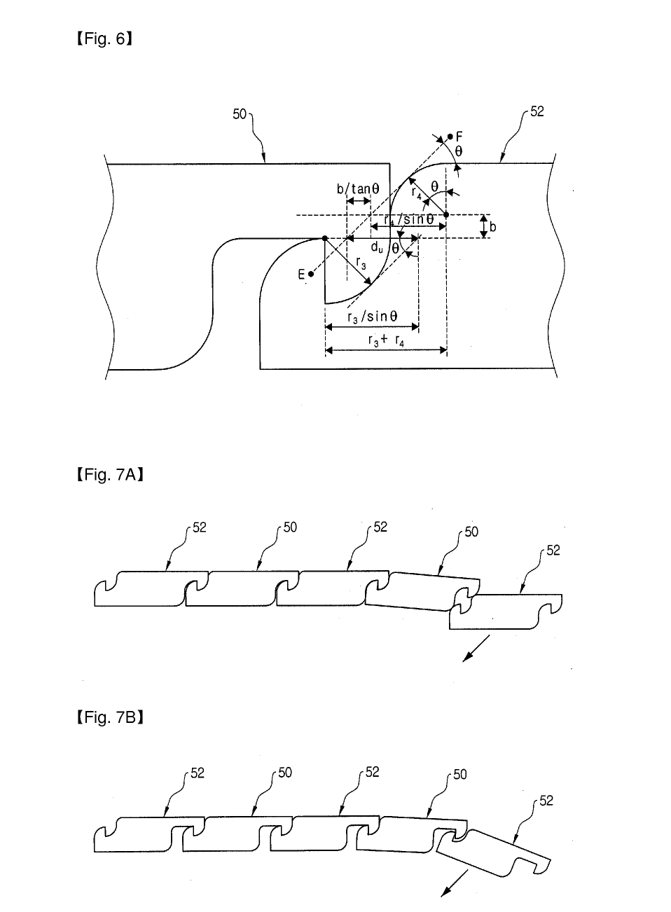

FIG. 6 shows an upper connection structure between strip members for pressure-supporting and easy pull-out, in a strip-connecting type spiral tube for pressure-supporting and easy pull-out disclosed herein.

As shown in FIG. 6, assuming that the upper connection structure is dismantled within lines E and F having a releasing angle θ as boundaries, interference is generated as much as the length corresponding to an interference interval d_{U} generated when the length b is determined between the center point of the arc radius r₃ and the center point of the arc radius r₄.

This interference makes the left and right strip members 50 and 52 shrink and thus be dismantled. Here, the interference interval d_{U} may be obtained by using Mathematical Formula 5.

$$Mathematical Formula 5$$

$$\begin{matrix}{d}_{U} = \frac{{r}_{3}}{sin θ} - ( {r}_{3} + {r}_{4} - \frac{{r}_{4}}{sin θ} - \frac{b}{tan θ} ) \\ = ( {r}_{3} + {r}_{4} ) ( \frac{1}{sin θ} - 1 ) + \frac{b}{tan θ}\end{matrix}$$

In Mathematical Formula 5, if the interference interval d_{U} is excessively great, the connection structure is not dismantled due to the great interference. Thus, a maximum length of the interference interval d_{U} allowing pull-out of the strip members is obtained when the distance b between the centers of the arc radius r₃ and the arc radius 4 is equal to a maximum shrinkable length ε_{f}(ε₃+r₄).

Thus, a condition for obtaining an upper connection structure for pressure-supporting and easy pull-out between strip members is:

$${ɛ}_{f} > ( \frac{1}{sin θ} - 1 ) + \frac{b}{( {r}_{3} + {r}_{4} ) tan θ} \qquad Mathematical Formula 6$$

For reference, ε_{f} is a maximum strain on the material of the strip member, and b is a distance between the center point of r₃ and the center point of r₄.

The following table comparatively shows analysis results on the connection structure depending on whether or not Mathematical Formula 2, Mathematical Formula 3, and Mathematical Formula 6 are satisfied.

Comparative Example 1 is a case where Mathematical Formulas 3 and 6 are satisfied but Mathematical Formula 2 is not satisfied, and settings for satisfying the condition are as follows: ε_{f}: 0.5, θ (angle, deg): 45, a (mm): 1.2, r₁ (mm): 0.5, r₂ (mm): 1.0, d (mm): 0.2, b (mm): 0, r₃ (mm): 1.0, and r₄ (mm): 0.5.

Comparative Example 2 is a case where Mathematical Formulas 2 and 6 are satisfied but Mathematical Formula 3 is not satisfied, and settings for satisfying the condition are as follows: ε_{f}: 0.5, θ (angle, deg): 45, a (mm): 1.2, r₁ (mm): 0.5, r₂ (mm): 1.0, d (mm): 0.7, b (mm): 0, r₃ (mm): 1.0, and r₄ (mm): 0.5.

Comparative Example 3 is a case where Mathematical Formulas 2 and 3 are satisfied but Mathematical Formula 6 is not satisfied, and settings for satisfying the condition are as follows: ε_{f}: 0.5, θ (angle, deg): 45, a (mm): 1.2, r₁ (mm): 0.5, r₂ (mm): 1.0, d (mm): 1.2, b (mm): 0.5, r₃ (mm): 0.5, and r₄ (mm): 1.0.

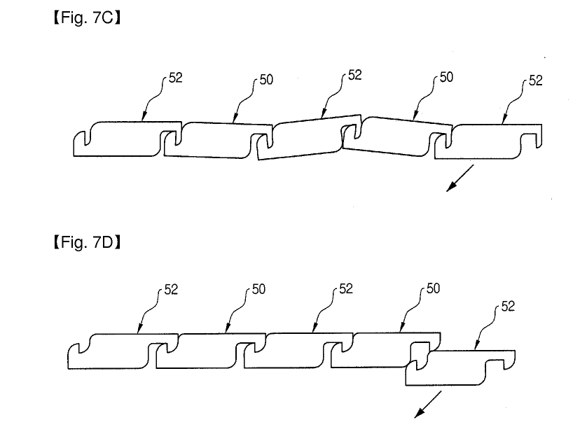

Comparative Example 4 is a case where all of Mathematical Formulas 2, 3 and 6 are satisfied, and settings for satisfying the condition are as follows: ε_{f}: 0.5, θ (angle, deg): 45, a (mm): 1.2, r₁ (mm): 0.5, r₂ (mm): 1.0, d (mm): 0.7, b (mm): 0, r₃ (mm): 1.0, and r₄ (mm): 0.5.

| Comparative Examples | 1 | 2 | 3 | 4 |
|---|---|---|---|---|
| ε_{f} | 0.5 | 0.5 | 0.5 | 0.5 |
| θ [deg.] | 45 | 45 | 45 | 45 |
| a [mm] | 1.2 | 1.2 | 1.2 | 1.2 |
| r₁ [mm] | 0.5 | 0.5 | 0.5 | 0.5 |
| r₂ [mm] | 1.0 | 1.0 | 1.0 | 1.0 |
| d [mm] | 0.2 | 0.7 | 1.2 | 0.7 |
| b [mm] | 0 | 0 | 0.5 | 0 |
| r₃ [mm] | 1.0 | 1.0 | 0.5 | 1.0 |
| r₄ [mm] | 0.5 | 0.5 | 1.0 | 0.5 |
| Mathematical Formula 2 satisfied? | X | ◯ | ◯ | ◯ |
| Mathematical Formula 3 satisfied? | ◯ | X | ◯ | ◯ |
| Mathematical Formula 6 satisfied? | ◯ | ◯ | X | ◯ |
| Analysis results on pressure- | FIG. 7A | FIG. 7B | FIG. 7C | FIG. 7D |
| supporting and easy pull-out | X | X | X | ◯ |

As seen from the table, in Comparative Example 1, narrowing occurs between strip members at the lower portion as shown in FIG. 7A. In Comparative Example 2, collapse occurs between strip members as shown in FIG. 7B. In Comparative Example 3, narrowing occurs between strip members at the upper portion as shown in FIG. 7C. In Comparative Example 4, the arrangement of strip members does not collapse due to pressure-supporting and easy upper and lower pull-out is allowed.

Meanwhile, in a case where Mathematical Formula 6 is satisfied but Mathematical Formula 4 is not satisfied, narrowing and arrangement collapse occur between strip members at the lower portion as shown in FIG. 7B. In a case where Mathematical Formula 4 is satisfied but Mathematical Formula 6 is not satisfied, narrowing occurs between strip members at the upper portion as shown in FIG. 7C.

In a case where both of Mathematical Formulas 4 and 6 are satisfied, the arrangement of strip members does not collapse due to pressure-supporting and easy upper and lower pull-out is allowed.

As a result, in order to prevent arrangement collapse caused by pressure-supporting and allow easy upper and lower pull-out of strip members, all of Mathematical Formulas 2, 3, and 6 should be satisfied. Or else, Mathematical Formulas 6 and 4 should be satisfied.

The strip-connecting type spiral tube for pressure-supporting and easy pull-out according to the present disclosure is expected to have optimal connection conditions so as to ensure easy pull-out between strip members adjacently connected and also to prevent the arrangement of strip members from collapsing due to an external pressure.

Thus, it is possible to produce a strip-connecting type spiral tube, which may allow easy pull-out between strip members and prevent the strip members from collapsing during pressure-supporting.

While the exemplary embodiments have been shown and described, it will be understood by those skilled in the art that various changes in form and details may be made thereto without departing from the spirit and scope of the present disclosure as defined by the appended claims.

In addition, many modifications can be made to adapt a particular situation or material to the teachings of the present disclosure without departing from the essential scope thereof. Therefore, it is intended that the present disclosure not be limited to the particular exemplary embodiments disclosed as the best mode contemplated for carrying out the present disclosure, but that the present disclosure will include all embodiments falling within the scope of the appended claims.

What is claimed is:

1. A spiral tube for pressure-supporting and easy pull-out, which includes strip members, which are segments, protrusion-side and hook-side coupling projections being respectively formed at both ends of the strip members, so that the strip members adjacent to each other are connected by coupling the protrusion-side and hook-side coupling projections,
wherein the protrusion-side coupling projection has an upper surface in which a protrusion-side arc-type convex surface and a protrusion-side arc-type concave surface are formed subsequently from a front end of the coupling projection toward a root portion, and the hook-side coupling projection has an upper surface in which a hook-side arc-type convex surface and a hook-side arc-type concave surface are subsequently formed from a front end of the coupling projection toward a root portion,
wherein the hook-side arc-type convex surface of the hook-side coupling projection has an arc of a base circle CA3 with a radius r₃, a region between a bottom side W1 and the hook-side arc-type concave surface having an arc of a base circle CA1 with a radius r₁, and
wherein the protrusion-side arc-type convex surface has an arc of a base circle CA2 with a radius r₂, a region between an upper side W3 and the protrusion-side arc-type concave surface having an arc of a base circle CA4 with a radius r₄.

2. The spiral tube according to claim 1, wherein the following formula is satisfied so that, when the strip member is released with a releasing angle θ, the strip member is pulled out while preventing an arrangement of strip members from collapsing:
$$a > d > ( 1 - {ɛ}_{f} ) [ {r}_{1} ( \frac{1}{sin θ} - 1 ) + {r}_{2} ( \frac{1}{sin θ} - 1 ) + ( a - {r}_{1} ) ( \frac{1}{sin θ cos θ} - tan θ ) ]$$
where r₁ and r₂ are arc radii, a is a thickness between a center point of r₂ and the bottom side W1, d is a spacing interval for a gap space S, θ is a releasing angle at which the strip member is separated, ε_{f} is a maximum strain on the material of the strip members, and a−r₁ is a distance between a center point of r₁ and the center point of r₂.

3. The spiral tube according to claim 1, wherein the following formula is satisfied so as to allow pull-out even when interference occurs between the strip members, when the strip member is released with a releasing angle θ:
$$d > ( 1 - {ɛ}_{f} ) [ {r}_{1} ( \frac{1}{sin θ} - 1 ) + {r}_{2} ( \frac{1}{sin θ} - 1 ) + ( a - {r}_{1} ) ( \frac{1}{sin θ cos θ} - tan θ ) ]$$
where r₁ and r₂ are arc radii, a is a thickness between a center point of r₂ and the bottom side W1, d is a spacing interval for a gap space S, θ is a releasing angle at which the strip member is separated, ε_{f} is a maximum strain on the material of the strip members, and a−r₁ is a distance between a center point of r₁ and the center point of r₂.

4. The spiral tube according to claim 1, wherein the following formula is satisfied so that the strip member does not collapse while rotating about a point O, when pressure-supporting is applied while connection is made between the strip members:
a>d
where a is a thickness between a center point of r₂ and a bottom side W1, and d is a spacing interval of a gap space S.

5. The spiral tube according to claim 1, wherein the following formula is satisfied so as to allow pull-out even when interference occurs between the strip members, when the strip member is released with a releasing angle θ:
$${ɛ}_{f} > ( \frac{1}{sin θ} - 1 ) + \frac{b}{( {r}_{3} + {r}_{4} ) tan θ}$$
where ε_{f} is a maximum strain on the material of the strip members, and b is a distance between a center point of r₃ and a center point of r₄.

6. The spiral tube according to claim 5, wherein the following formula is satisfied so that, when the strip member is released with a releasing angle θ, the strip member is pulled out while preventing an arrangement of strip members from collapsing:
$$a > d > ( 1 - {ɛ}_{f} ) [ {r}_{1} ( \frac{1}{sin θ} - 1 ) + {r}_{2} ( \frac{1}{sin θ} - 1 ) + ( a - {r}_{1} ) ( \frac{1}{sin θ cos θ} - tan θ ) ]$$
where r₁ and r₂ are arc radii, a is a thickness between a center point of r₂ and the bottom side W1, d is a spacing interval for a gap space S, θ is a releasing angle at which the strip member is separated, ε_{f} is a maximum strain on the material of the strip members, and a−r₁ is a distance between a center point of r₁ and the center point of r₂.

7. The spiral tube according to claim 1, wherein all of the following formulas are satisfied so as to allow upper and lower pull-out between the strip members without arrangement collapse caused by pressure-supporting, when the strip member is released with a releasing angle (θ):
$$d > ( 1 - {ɛ}_{f} ) [ {r}_{i} ( \frac{1}{sin θ} - 1 ) + {r}_{2} ( \frac{1}{sin θ} - 1 ) + ( a - {r}_{1} ) ( \frac{1}{sin θ cos θ} - tan θ ) ]$$
$$a > d$$
$${ɛ}_{f} > ( \frac{1}{sin θ} - 1 ) + \frac{b}{( {r}_{3} + {r}_{4} ) tan θ }$$
where r₁, r₂, r₃, and r₄ are arc radii, a is a thickness between a center point of r₂ and the bottom side W1, b is a distance between a center point of r₃ and a center point of r₄, d is a spacing interval for a gap space S, θ is a releasing angle at which the strip member is separated, c is a maximum strain on the material of the strip members, and a−r₁ is a distance between a center point of r₁ and the center point of r₂.
